(19) United States
(12) Patent Application Publication
(10) Pub. No.: US 2010/0188576 A1
(43) Pub. Date: Jul. 29, 2010

(54) Image display device and method for displaying an image

(75) Inventor: Toshiaki Mizushima, Osaka (JP)

Correspondence Address: MASUVALLEY & PARTNERS, 8765 AERO DRIVE, SUITE 312, SAN DIEGO, CA, 92123, US

(73) Assignee: Sanyo Electric Co., Ltd., Moriguchi (JP)

(21) Appl. No.: 12/321,686

(22) Filed: Jan. 23, 2009

(51) Int. Cl. H04N 3/27; H04N 5/66; H04N 5/50

(52) U.S. Cl. 348/554; 348/739; 348/731; 348/E05.133; 348/E05.097; 348/E03.049

(57) ABSTRACT

An image display device includes a display that shows an image based on image data, a first interface that is connected to a storage medium, the storage medium having the image data, a second interface, and a controller that selects the interface from which the image data of the image to be shown by the display is inputted. The controller selects the second interface when moving image data is detected in the storage medium while the controller selects the first interface.

### TECHNICAL FIELD

The present invention relates to an image display device, such as television receivers, and a method for displaying an image by the image display device.

### BACKGROUND OF THE INVENTION

In recent years, there is a so called photo viewer function as an added function for television receivers. The photo viewer function is basically as follows. Firstly, a digital camera is connected to a television receiver via a USB (Universal Serial Bus) interface. The television receiver recognizes the digital camera as a USB storage device. Then, the television receiver displays still image data, such as JPEG data, stored in the digital camera on a display by decoding the data with software provided in the television receiver.

Meanwhile, home electric appliances provided with a standard interface called HDMI (High-Definition Multimedia Interface) have been becoming common. HDMI is an interface for digital home electric appliances and an uncompressed digital audio and image can be communicated via HDMI. Further, since control signals can be communicated between devices by using CEC (Consumer Electronics Control) defined by HDMI version 1.2a, a linkage between the devices can easily be established. Further, wirings between the devices can be simplified because cables are formed from a single cable integrating an image, an audio and a control signal.

For example, in a case when a television receiver having HDMI-CEC is connected to a digital camera having HDMI-CEC, the digital camera can be operated from the television receiver side. Concretely, firstly, a user switches an input of the television receiver to a HDMI input. Next, the user reproduces a still image or a moving image with a decoding function, which is provided to the digital camera, by operating the digital camera from the television receiver side. Then the reproduced image is displayed on a screen of the television receiver via the HDMI input. In a case when the digital camera is connected to the HDMI of the television receiver in this way, not only the still image but also the moving image can be displayed on the screen of the television receiver.

However, in a case when displaying the image data stored in the storage medium, such as digital camera which is connected to the USB using the photo viewer function of the television receiver, the still image data can be displayed but the moving image data such as MPEG, can not be displayed. This is because the photo viewer function can normally decode the still image only.

Accordingly, in order to display the moving data by the photo viewer function of the television receiver, a decoder chip for reproducing the moving image data or a high-speed CPU for enabling to decode the moving image data with software is needed to be provided in the television receiver. However, these means lead to an increase of cost of the television receiver.

Further, it is difficult for a user to figure out how to reproduce the moving image data on the television receiver if the user does not know that the photo viewer function cannot reproduce the moving image data. Also, such a user gets confused by not understanding the reason why the moving image cannot be displayed but the still image could be displayed.

Accordingly, a main objective of the present invention is to enable to display moving image data in an external storage medium without confusing users or increasing the cost when playing the image data in the external storage medium by a decoder, such as a photo viewer function of a television receiver, which can only play still image data.

### SUMMARY OF THE INVENTION

In accordance with a first aspect of the invention, an image display device includes:

a display that shows an image based on image data;

a first interface that is connected to a storage medium, the storage medium having the image data;

a second interface; and

a controller that selects the interface from which the image data of the image to be shown by the display is inputted;

wherein the controller selects the second interface when moving image data is detected in the storage medium while the controller selects the first interface.

According to the first aspect of the present invention, the controller switches the input to the second interface when the moving image data is detected in the storage medium. Accordingly, the moving image data in the storage medium can be displayed without confusing the user when, for example the moving image data cannot be displayed on the display by the input via the first interface, but the moving image data can be displayed on the display by the input via the second interface. Further, the cost of the image display device will not be increased because the first aspect of the preset invention can be achieved only by changing the control method of the controller. That is, this is because a decoder chip for reproducing the moving image data or a high-speed CPU for enabling to decode the moving image data with software is not needed to be provided to the image display device.

In the first aspect of the invention, the controller may instruct the storage medium to decode the moving image data via the second interface after the controller has selected the second interface.

According to this aspect, a moving image based on the moving image data is displayed on the display without having the user to operate the storage medium. Therefore, the trouble for having the user to operate the storage medium can be eliminated.

In the first aspect of the invention, the first interface may be a USB (Universal Serial Bus) interface.

According to this aspect, various storage media, such as a digital camera, a cellular phone, a PDA and a portable music player, can be connected to the first interface.

In the first aspect of the invention, the second interface may be HDMI (High-Definition Multimedia Interface) interface.

According to this aspect, various storage media, such as a digital camera, a cellular phone, a PDA and a portable music player can be connected to the second interface. Further, since HDMI can transmit an uncompressed digital audio and image, it is suitable for transmitting decoded moving image signals.

In the first aspect of the invention, the controller may confirm whether or not the second interface is connected to an apparatus after the moving image data has been detected in the storage medium. Further, the controller may allow the display to show a message after the controller has confirmed that the second interface is not connected to the apparatus.

According to this aspect, a situation where no image data is inputted can be avoided when the input is switched to the second interface. Further, this situation confuses a user who does not know the storage medium is needed to be connected to the second interface. Therefore, this aspect can suppress the confusion of the user. Further, by displaying the message, the user can easily be notified how to display the moving image data on the display.

In the first aspect of the invention, the controller may include a processor and a memory, and the memory may have a program for decoding still image data.

According to this aspect, the controller can decode the still image data in the storage medium with software.

In the first aspect of the invention, the storage medium may have a decoder for decoding the moving image data.

According to this aspect, the storage medium can decode the moving image data.

In the first aspect of the invention, the image display device may further include:

a tuner that receives a signal of digital broadcasting;

a demodulator that demodulates the signal inputted from the tuner and that outputs a transport stream;

a demultiplexer that demultiplexes the transport stream and that outputs an elementary stream;

a video and audio decoder that decodes the elementary stream and that outputs a video and audio signal; and

an on screen display multiplexer that overlaps operation screen over the video signal, the on screen display multiplexer being connected to the display.

According to this aspect, the image display device has a function of the television receiver. Therefore, although it is a television receiver, the moving image data in the storage medium can be displayed on the display without confusing the user.

In accordance with a second aspect of the invention, an image display device includes:

a display that shows an image based on image data;

a first interface to which a storage medium that has the image data is connected;

a second interface; and

a controller that makes the display show the image based on an input from the first or the second interface;

wherein the controller makes the display show a message that urges a user to connect the storage medium to the second interface when moving image data is detected in the storage medium through the first interface.

According to the second aspect of the present invention, the controller display the message to prompt the user to connect the storage medium to the second interface when the moving image data is detected in the storage medium. Accordingly, the user can easily be notified how to display the moving image data on the display when, for example, the moving image data can not be displayed on the display by the input via the first interface but the moving image data can be displayed on the display by the input via the second interface. Therefore, the user will not be confused. Further, the cost of the image display device will not be increased because the second aspect of the preset invention can be achieved only by changing the control method of the controller. That is, this is because a decoder chip for reproducing the moving image data or a high-speed CPU for enabling to decode the moving image data with software is not needed to be provided to the image display device.

In the second aspect of the invention, the controller may make the display show the message after the controller has confirmed that the second interface is not connected to the apparatus.

According to this aspect, the display of the message can be omitted when the user has already connected to the apparatus to the second interface. Therefore, convenience to the user can be enhanced.

In the second aspect of the invention, the first interface may be a USB (Universal Serial Bus) interface.

According to this aspect, various storage media, such as a digital camera, a cellular phone, a PDA and a portable music player can be connected to the first interface.

In the second aspect of the invention, the second interface may be an HDMI (High-Definition Multimedia Interface) interface or a composite video signal interface.

According to this aspect, various storage media, such as a digital camera, a cellular phone, a PDA and a portable music player, can be connected to the second interface. Further, since HDMI can transmit an uncompressed digital audio and image, it is suitable for transmitting decoded moving image signals. Further, the composite image signal interface can also transmit decoded moving image signals. Although the composite image signal interface has lower picture quality comparing with HDMI, there is an advantage that many devices are compatible with this interface.

In the second aspect of the invention, the controller may include a processor and a memory, and the memory may have a program for decoding still image data.

According to this aspect, the controller can decode the still image data in the storage medium by software.

In the second aspect of the invention, the storage medium may have a decoder for decoding the moving image data.

According to this aspect, the storage medium can decode the moving image data.

In the second aspect of the invention, the image display device may further include:

a tuner that receives a signal of digital broadcasting;

a demodulator that demodulates the signal inputted from the tuner and that outputs a transport stream;

a demultiplexer that demultiplexes the transport stream and that outputs an elementary stream;

a video and audio decoder that decodes the elementary stream and that outputs a video and audio signal; and

an on screen display multiplexer that overlaps operation screen over the video signal, the on screen display multiplexer being connected to the display.

According to this aspect, the image display device also has a function of the television receiver. Therefore, although it is a television receiver, the moving image data in the storage medium can be displayed on the display without confusing the user.

In accordance with a third aspect of the invention, a method for displaying an image by an image display device connected to a storage medium having image data via a first interface includes the steps of:

checking whether or not moving image data exist in the storage medium while playing a still image by an input from the first interface; and

changing the input from the first interface to a second interface when the moving data exists in the storage medium.

According to the third aspect of the present invention, the input is switched to the second interface from the first interface when the moving image data is detected in the storage medium. Accordingly, the moving image data in the storage medium can be displayed without confusing the user when, for example, the moving image data cannot be displayed on the display by the input via the first interface but the moving image data can be displayed on the display by the input via the second interface. Further, the cost of the image display device will not be increased because the third aspect of the preset invention can be achieved only by changing the control method of the controller. That is, this is because a decoder chip for playing the moving image data or a high-speed CPU for enabling to decode the moving image data with software is not needed to be provided to the image display device.

In the third aspect of the invention, the method may further include the step of:

instructing the storage media to decode the moving image data via the second interface after changing the input from the first interface to the second interface.

According to this aspect, a moving image based on the moving image data is displayed on the display without having the user to operate the storage medium. Therefore, the trouble for having the user to operate the storage medium can be eliminated.

In the third aspect of the invention, the method may further include the steps of:

checking whether or not an apparatus is connected to the second interface before changing the input from the first interface to the second interface when the moving data exists in the storage medium; and

showing a message that urges a user to connect the storage medium to the second interface when the apparatus is not connected to the second interface.

According to this aspect, the user can easily be notified how to display the moving image data on the display. Therefore, the user will not be confused.

In the third aspect of the invention, the method further including include the steps of:

checking whether or not the storage media is connected to the second interface via HDMI (High-Definition Multimedia Interface)—CEC (Consumer Electronics Control) after changing the input from the first interface to the second interface; and

showing a message that asks a user to reproduce the moving image data by the storage medium when the storage media is not connected to the second interface by HDMI-CEC.

According to this aspect, the user can be notified that the user needs to operate the storage medium to reproduce the moving image data in order to display the moving image data in the storage medium on the display.

### BRIEF DESCRIPTION OF THE DRAWINGS

FIG. 1 is a block diagram showing an outline configuration of an image display device according to an embodiment of the present invention. Here, a storage medium is connected to the image display device.

FIG. 2 illustrates a flowchart showing operations when a photo viewer function is performed according to an embodiment of the present invention.

### DETAILED DESCRIPTION OF INVENTION

Preferred embodiments pertaining to the present invention will be explained in detailed with reference to figures. In addition, the same symbol will be given to the identical or similar elements in the specification and figures, thereby the explanations of those will be omitted.

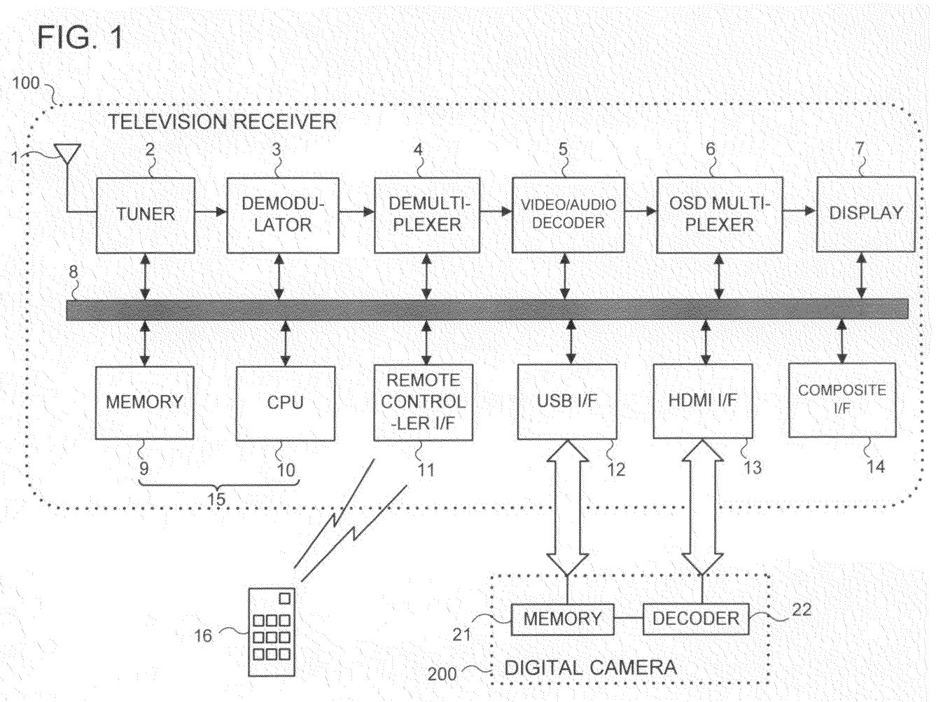

FIG. 1 is a block diagram showing an outline configuration of an image display device according to an embodiment of the present invention. Here, a storage medium is connected to the image display device.

In the embodiment, a television receiver 100 is explained as an example of the image display device. Displays for personal computers, cellular phones, PDAs (Personal Digital Assistant) and the like may be listed as other image display devices.

An antenna 1 of the television receiver 100 receives terrestrial, BS, and CS digital broadcasting.

A tuner 2 is connected to the antenna 1. A digital broadcast signal is inputted to the tuner 2 from the antenna 1. The tuner 2 picks up a signal with a specific frequency from a high-frequency digital modulated signal containing video/audio data.

A demodulator 3 is connected to the tuner 2. The demodulator 3 outputs a transport stream (hereinafter referred as TS) by demodulating a digital modulated signal inputted from the tuner 2. The TS is data of compressed information of video, audio and the like.

A demultiplexer 4 is connected to demodulator 3. The demultiplexer 4 separates the TS inputted from the demodulator 3 into video, audio and other adjunct information. The separated TS is outputted as an elementary stream (hereinafter referred as ES).

A video/audio decoder 5 is connected to demultiplexer 4. The video/audio decoder 5 decodes the ES inputted from the demultiplexer 4 and outputs a video signal and an audio signal.

An OSD multiplexer 6 is connected to the video/audio decoder 5. The OSD multiplexer 6 superimposes screens for television operations and other operation menus onto the video signal, which is inputted from the video/audio decoder 5, as an OSD (On Screen Display).

A display 7 is connected to the OSD multiplexer 6. The display 7 displays an image according to the video signal inputted from the OSD multiplexer 6. Further, the display 7 also displays an image according to other video data inputted through a system bus 8. In this case, the image may be a still image or a moving image.

The system bus 8 is a signal line connecting blocks in the television receiver 100. Each of the tuner 2, the demodulator 3, the demultiplexer 4, the video/audio decoder 5, the OSD multiplexer 6 and the display 7 described above is connected to the system bus 8.

A memory 9 holds a control program for controlling and operating all of the blocks in the television receiver 100, a program for a so-called photo viewer function to reproduce decoded still image data, and the like. The memory 9 also holds video, audio and other data. According to the control program, for example, an interface to which image data for an image to be displayed on the display 7 is inputted, is selected. That is, an input of the television receiver 100 is switched. In addition, the control program includes distinctive operations of the present invention, however, this will be described later. Further, the photo viewer function is capable of reproducing still image data, such as JPEG data, stored in an external storage medium by decoding the data with software. However, the photo viewer function of the embodiment cannot decode moving image data. In addition, it is technically viable to decode the moving image data by the photo viewer function. However, a high-speed CPU is required for decoding the moving image data with software. Further, a decoder chip is required to decode the moving image data by hardware. Either of means has a disadvantage which leads to an increase in the cost of the television receiver 100.

A CPU 10 is the CPU for executing the various programs described above.

The memory 9 and the CPU 10 configure a controller 15. Therefore, in other words, it can be said that the controller 15 selects the interface to which the image data of the image to be displayed on the display 7 is inputted. Further, the controller 15 displays an image to the display 7 according to some sort of inputs. As this input, television broadcast data received by the antenna 1, image data inputted from a USB I/F 12, image data inputted from a HDMI I/F 13 and the like may be listed. In the embodiment, the controller 15 is to allow the CPU 10 to execute the program stored in the memory 9. However, the same function may be made up by hardware.

A remote controller I/F 11 is an interface for receiving signals from a remote controller 16 to operate the television receiver 100.

The USB I/F 12 is compatible to a first interface of the present invention. The USB I/F 12 is an interface of USB (Universal Serial Bus) standards. Digital cameras, cellular phones, PDAs, portable music players, external memory media, such as memory sticks, and other peripheral devices may be connected to the USB I/F 12.

The HDMI I/F 13 is compatible to a second interface of the present invention. The HDMI I/F 13 is an interface of HDMI (High-Definition Multimedia Interface) standards. Devices, such as DVD (Digital Versatile Disc) recoder/players, HD (Hard Disk) recoder/players, game devices, personal computers, digital cameras, cellular phones, PDAs and portable music players may be connected to the HDMI I/F 13. The HDMI can transmit uncompressed digital audio and video. Further, the HDMI has an intelligent function which enables the devices that are connected to recognize each other. In addition, the HDMI of the television receiver 100 pertaining to the embodiment has a CEC (Consumer Electronics Control) function. The CEC is the function defined by HDMI version 1.2a which enables devices to transmit control signals with each other. By using the CEC, linked operations between the devices can be realized by transmitting control signals through a HDMI cable. For example, the devices connected to the HDMI can be operated by the remote control 16 of the television receiver. In addition, the HDMI having a CEC function may also be referred as “HDMI-CEC” in the explanation below.

A composite I/F 14 is an interface for inputting a composite video signal. The composite video signal is a composite picture signal which has a capability to simultaneously handle brightness signals and color signals that are forming an image by combining them. The composite video signal is a signal used in analog television broadcasting. The composite I/F 14 is also capable of transmitting a decoded moving image signal. Although the picture quality of the composite I/F 14 is lower compared to the HDMI I/F 13, there is an advantage in compatibility of many devices to the composite I/F 14.

Each of the memory 9, the CPU 10, the remote controller I/F 11, the USB I/F 12, the HDMI I/F 13 and the composite I/F 14 are also connected to the system bus 8.

Further, in this embodiment, a digital camera 200 as a storage medium is connected to the television receiver 100. Cellular phones, PDAs, portable music players, USB memory sticks and the like may be listed as other storage media.

The digital camera 200 is connected to the USB I/F 12 and HDMI I/F 13 respectively. The digital camera 200 of the embodiment has the HDMI with a CEC function. Further, still image data, such as JPEG, and moving image data, such as MPEG 4 are stored in a memory 21 in the digital camera 200. This still image data is acquired by a still image photographing function of the digital camera 200, for example. This moving image data is acquired by a moving image recoding function of the digital camera 200, for example. Further, since the digital camera 200 has a decoder 22, the digital camera 200 has a decoding function. The decoder 22 is to decode the still image data or moving image data that is stored in the memory 21 and to play the data.

The digital camera 200 is connected to the USB I/F 12. For this reason, the still image data stored in the digital camera 200 can be communicated to the television receiver 100 via the USB I/F 12. In such a case, the television receiver 100 can decode the still image data by the photo viewer function and display on the display 7. Meanwhile, the moving image data stored in the digital camera 200 can also be communicated to the television receiver 100 via the USB I/F 12. However, as described above, since the photo viewer function of the television receiver 100 in the embodiment cannot play the moving image data, the moving image data cannot be displayed on the display 7 by the photo viewer function.

Further, the digital camera 200 is also connected to the HDMI I/F 13. The HDMI can transmit the uncompressed digital audio and video to the television receiver. For this reason, firstly, a user operates the digital camera 200 to decode (reproduce) the still image data and moving image data stored in the digital camera 200 using the decoding function provided to the digital camera 200. Next, the decoded uncompressed still image data and moving image data are transmitted to the television receiver 100 via the HDMI I/F 13. And the television receiver 100 which received the decoded uncompressed still image data and moving image data, can display the data on the display 7. In addition, the HDMI of the embodiment has the CEC function as described above. For this reason, the television receiver 100 can also instruct the digital camera 200 to decode the moving image data. In such a case, the user does not need to operate the digital camera 200 to reproduce the image data.

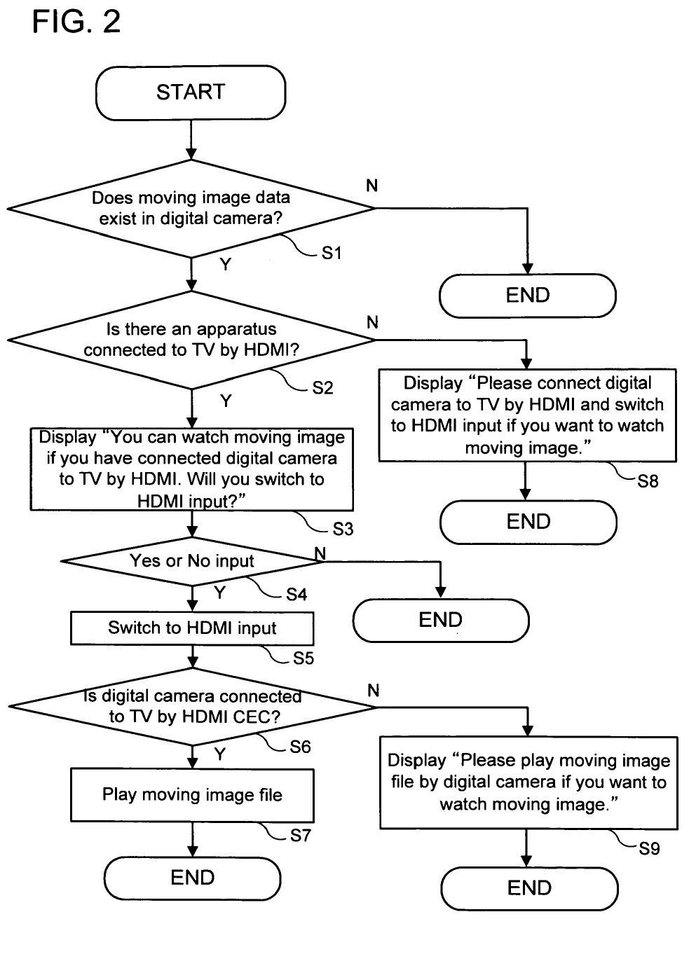

Next, operations of the image display device pertaining to the embodiment of the present invention will be explained with reference to FIGS. 1 and 2. FIG. 2 is a flow chart illustrating operations when the photo viewer function pertaining to the embodiment of the present invention is executed.

The operation of the image display device pertaining to the embodiment of the present invention is mainly controlled by executing a controlling program stored in the memory 9 by the CPU 10. In other words, the operation of the image display device pertaining to the embodiment of the present invention is controlled by the controller 15.

Firstly, a user turns on the power of the television receiver 100 using the remote controller 16. An instruction from the remote controller 16 is transmitted to the television receiver 100 via the remote controller I/F 11. Thereafter, the memory 9 and the CPU 10 (controller 15) control the television receiver 100 as follows.

The tuner 2 and demodulator 3 select a program on a channel which is set up as a prescribed value, and output the TS to the demultiplexer 4.

The demultiplexer 4 demultiplexes the inputted TS into the video, audio, and other adjunct information. Next, the demultiplexer 4 outputs the demultiplexed TS as the ES. At this time, in case when the inputted TS is a TS in which a plurality of channels are multiplexed, the TS corresponding to the channel which is set up as the prescribed value from the plurality of channels, is extracted. Accordingly, the TS is demultiplexed into the video, audio and other adjunct information, and outputted as the ES.

The video/audio decoder 5 decodes the ES of the channel and outputs the video signal and audio signal to the OSD multiplexer 6.

The OSD multiplexer 6 superimposes the screens for television operations and other operating menus to the video signal as the OSD.

The display 7 displays an image according to the video signal to which the OSD has been superimposed.

Here, in a case when the user switches the channel by the remote controller 16, the tuner 2 is controlled via the remote controller I/F 11 as needed. The tuner 2 selects a physical channel corresponding to the set channel. Then, the ES corresponding to the set channel is extracted by the demodulator 3 and demultiplexer 4. Thereafter, the video and audio of the selected channel is outputted by the same operation as described above.

Further, in a case when the user switches the input of the television receiver 100 to the HDMI input using the remote controller 16, the input of the television receiver 100 is switched to the HDMI I/F 13. That is, the controller 15 selects the HDMI I/F 13 as the interface to which the image data of the image to be displayed on the display 7 is inputted. The video signal inputted from the HDMI I/F 13 is displayed on the display 7. In this embodiment, the digital camera 200 is connected to the HDMI I/F 13. Therefore, the still image data or moving image data stored in the digital camera 200 can be decoded (reproduced) using the decoding function provided in the digital camera 200 and displayed the data on the display 7. Further, by applying the CEC function of the HDMI, the user can operate the digital camera 200 with the remote controller 16 and the like to reproduce the still image data or moving image data. In such a case, the user controls the HDMI I/F 13 via the remote controller I/F 11.

Further, in a case when the user selects the photo viewer function with the remote controller 16, the input of the television receiver 100 is switched to the USB I/F 12. That is, the controller 15 selects the USB I/F 12 as the interface to which the image data of the image to be displayed on the display 7 is inputted. The memory 21 in the digital camera 200 is recognized as a mass storage class which is connected to the USB I/F 12. The user controls the USB I/F 12 via the remote controller I/F 11. The still image data, such as JPEG, in the memory 21 is read via the USB I/F 12, decoded by the software in the television receiver 100, and outputted to the display 7. The basic operations of the photo viewer function are as described above. Further, the distinctive operations in the present invention will be explained using the flow chart shown in FIG. 2.

Following operation is controlled by the CPU 10 which executes the control program stored in the memory 9. In other words, the following operation is controlled by the controller 15. Further, since the photo viewer function is selected, the controller 15 is selecting the USB I/F 12 as an input interface at the initial state.

In addition, in the explanation of the image display device pertaining to the embodiment of the present invention described above, the digital camera 200 is connected to the HDMI I/F 13. However, in the following, the explanation will be made on the basis that whether or not the digital camera is connected to the HDMI I/F 13 is unknown. Similarly, in the explanation of the image display device pertaining to the embodiment of the present invention described above, the digital camera 200 has the HDMI-CEC function. However, in the following, the explanation will be made on the basis that whether or not the digital camera 200 has the HDMI-CEC function is unknown.

In step S1, the controller 15 determines whether or not moving image data, such as MEPG 4, exists in the memory 21 in the digital camera 200. When the moving image data is detected as a result, the process proceeds to step S2. When the moving image is not detected, the process is completed. Then, the process returns to a normal photo viewer function.

In step S2, the controller 15 determines whether or not some sort of apparatuses including the digital camera 200 are connected to the HDMI I/F 13. Concretely, the controller 15 checks to see if a communication can be established between the apparatus connected to the HDMI I/F 13. When some sort of apparatuses are connected to the HDMI I/F 13 as a result, the process proceeds to step S3. When any apparatus is not connected to the HDMI I/F 13, the process proceeds to step S8. In addition, this step S2 may be omitted. However, in case when step S2 is omitted, there may be a case where no image data is inputted even the input is switched to the HDMI input in subsequent step S5. In such a case, the user who does not know the digital camera 200 needs to be connected by the HDMI, the user will be confused. Therefore, it is more preferable to execute the step S2 because the confusion of the user can be suppressed.

In step S3, the controller 15 displays a message for questioning whether the user to switch the input to the HDMI input or not, on the display 7. For example, the controller 15 displays a message to the display 7 saying “You can watch moving image if you have connected digital camera to TV by HDMI. Will you switch to HDMI input?” Then, the controller requests the user to input yes or no.

When the user inputs “Yes” in step S4, the process proceeds to step S5. When the user inputs “No”, the process is finished and returns to the normal photo viewer function. In addition, these steps S3 and S4 can be omitted. However, in a case when steps S3 and S4 are omitted, the input is forcibly switched to HDMI input in the subsequent step S5 even when the user thinks it is “OK” to just view still images with the photo viewer function. Therefore, it is more preferable to execute steps S3 and S4 because the convenience for the user can be enhanced.

In step S5, the controller 15 switches the input of the television receiver 100 to the HDMI input. That is, the controller 15 selects the HDMI I/F 13 as the interface for inputting the image data of the image to be displayed on the display 7. Accordingly, the display 7 is switched to the screen of the digital camera 200 which is connected to the HDMI I/F 13. The operation in this step means that the input is automatically switched to the HDMI input without having the user to perform the operation to switch to the HDMI input. Therefore, the user will not be confused, and the trouble for having the user perform an operation is also eliminated.

In step S6, the controller 15 determines whether or not the digital camera 200 is connected to the television receiver 100 via the HDMI-CEC. Concretely, the controller 15 checks to see if a communication between the digital camera 200 can be established on the CEC signal line of the HDMI. When the digital camera 200 is connected to the television receiver 100 via the HDMI-CEC, as a result, the process proceeds to step S7. When the digital camera 200 is not connected to the television receiver 100 by via HDMI-CEC, the process proceeds to step S9. In addition, this step S6 may be omitted. However, in a case when the step 6 is omitted, the moving image data cannot be automatically reproduced in subsequent step S7 when the storage medium connected to the HDMI input is not compatible to the HDMI-CEC standard. For this reason, the user who does not know the moving image data will not be automatically reproduced, will be confused when the storage medium is not connected by the HDMI-CEC. Therefore, it is more preferable to execute the step S6 because the convenience to the user can be enhanced.

In step S7, the controller 15 reproduces the moving image data in the memory 21 in the digital camera 200. Concretely, the controller 15 instructs the digital camera 200 to reproduce (decode) the moving image data by the HDMI-CEC function. The digital camera 200, which received the instruction, decodes the moving image data in the memory 21 with the decoder 22 provided in the digital camera 200. The decoded moving image data is transmitted to the television receiver 100 via the HDMI I/F 13. The television receiver 100 displays the moving image data on the display 7. The operation in this step S7 means that the moving image data is automatically reproduced without having the user perform the operation to reproduce the moving image data by the digital camera. Therefore, the user will not be confused, and the trouble for having the user perform the operation is also eliminated. In addition, this step S7 may be omitted. However, the user has to reproduce the moving image data by operating the digital camera when the step S7 is omitted. Therefore, it is preferable to execute step S7 because the convenience to the user can be enhanced.

In step S8, the controller 15 displays a message which prompts the user to connect the digital camera 200 to the HDMI I/F 13 on the display 7. For example, the controller 15 displays a message saying “Please connect digital camera to TV by HDMI and switch to HDMI input if you want to watch moving image” on the display 7. Accordingly, the user can be notified that the HDMI connection is necessary to display the moving image data in the digital camera to the television receiver 100. Therefore, how the moving image data can be displayed on the television receiver 100 can be easily notified to the user. Here, in a case when the television receiver 100 has an interface for composite image signals, such as the composite I/F 14, the user may be notified that the digital camera 200 can be connected to the interface for the composite image signals. In such a case, a message such as “Please connect digital camera to TV by HDMI or composite terminal and switch to respective input if you want to watch moving image”, will be displayed, for example. In this case, it is favorable because it is possible to notify the user how to display the moving image on the screen of the television receiver 100, even in the case when the digital camera is not compatible with the HDMI standards.

In addition, in the present invention, the process is transitioned to the step S8 via step S2. However, step S8 may be executed in stead of step S2. In such a case, the message to the user is displayed in step S8 when the moving image data is determined to be existed in the digital camera 200 in step S1. In this way, the user can also be easily notified how to display the moving image data on the television receiver 100. However, in the case when step S8 is executed without performing step S2, the user is also prompted to connect the digital camera 200 to the HDMI I/F 13 in step S8 even when the digital camera has already been connected to the HDMI I/F 13. Accordingly, the convenience to the user can be enhanced by executing the step S8 after going through the step S2 as described in the embodiment.

In step S9, the controller 15 displays a message on the display 7 to notify the user that the user him/herself needs to perform an operation for reproducing the moving image data by the digital camera 200. For example, the controller 15 displays a massage saying “Please play moving image file by digital camera if you want to watch moving image” on the display 7. Accordingly, the user can be notified that the user him/herself needs to operate the digital camera to decode (play) the moving image data in order to display the moving image data in the digital camera on the television receiver 100.

The operation described above is preferably executed at first after the user selects the photo viewer function. This is because viewing the image will not be interrupted while the user is viewing the images in series by the photo viewer function if the operation is executed at first. However, the operation described above may be executed each time the image data to be displayed on the display 7 is selected while executing the photo viewer function. According to this method, the time to firstly check whether or not the moving image data is contained in all of the image data in the storage medium can be eliminated. Accordingly, there is an advantage of enabling the user to quickly start viewing the still image data in the storage medium by the photo viewer function.

According to the embodiments of the present invention described above, the controller 15 switches the input of the television receiver 100 to the HDMI I/F 13 when the moving image data is detected in the digital camera 200, which is connected to the USB I/F 12. Thus, the moving image data in the digital camera 200 can be displayed without confusing the user. Further, the embodiment can be realized just by changing the control program in the memory 9. That is, there is no need to provide the television receiver 100 with a decoder chip for playing the moving image data, or a high-speed CPU for enabling to decode the moving image data with software. Therefore, the cost will not be increased.

Further, according to the embodiments of the present invention, the television receiver 100 can automatically reproduce the moving image data in the memory 21 in the digital camera 200 when the digital camera 200 is connected to the television receiver 100 by the HDMI-CEC. Accordingly, the moving image data is displayed on the television receiver 100 without having the user operate the digital camera. Therefore, the trouble for the user to operate the digital camera 200 can be eliminated.

Further, according to the embodiments of the present invention, the message to prompt the user to connect the digital camera 200 to the HDMI I/F 13 is displayed when the digital camera 200 is not connected to the HDMI I/F 13. Accordingly, the user can understand how to display the moving image in the digital camera 200 on the television receiver 100. Therefore, the moving image data in the digital camera 200 can be displayed without confusing the user.

The embodiments of the present invention have been concretely explained with reference to the drawings. However, the present invention is not limited to the embodiment shown in the figures. Various changes and modification can be applied to the embodiment in the figures within the same or equal technical scope of the present invention.

For example, the formation or the operation of the image display device or the storage medium described above is merely an example, and changes and modification can be made arbitrarily. Concretely, the television receiver 100 as the image display device may be a display of a personal computer, a cellular phone, a PDA (Personal Digital Assistant) and the like. The USB I/F 12 as the first interface may be an interface of another standard having a similar function. Further, the HDMI I/F 13 as the second interface may be an interface of another standard having a similar function. The digital camera 200 as the storage medium may be a cellular phone, a PDA, a portable music player, a USB memory stick and the like. The operation flow while executing the photo viewer function may be arbitrarily changed. The contents of the message displayed on the display may also be arbitrarily changed.

What is claimed is:

1. An image display device comprising:
a display that shows an image based on image data;
a first interface that is connected to a storage medium, the storage medium having the image data;
a second interface; and
a controller that selects the interface from which the image data of the image to be shown by the display is inputted;
wherein the controller selects the second interface when moving image data is detected in the storage medium while the controller selects the first interface.

2. The image display device of claim 1, wherein the controller instructs the storage medium to decode the moving image data via the second interface after the controller has selected the second interface.

3. The image display device of claim 1, wherein the first interface is a USB (Universal Serial Bus) interface.

4. The image display device of claim 1, wherein the second interface is HDMI (High-Definition Multimedia Interface) interface.

5. The image display device of claim 1, wherein the controller confirms whether or not the second interface is connected to an apparatus after the moving image data has been detected in the storage medium.

6. The image display device of claim 5, wherein the controller makes the display show a message after the controller has confirmed that the second interface is not connected to the apparatus.

7. The image display device of claim 1, wherein the controller includes a processor and a memory, and the memory has a program for decoding still image data.

8. The image display device of claim 1, wherein the storage medium has a decoder for decoding the moving image data.

9. The image display device of claim 1, further comprising:
a tuner that receives a signal of digital broadcasting;
a demodulator that demodulates the signal inputted from the tuner and that outputs a transport stream;
a demultiplexer that demultiplexes the transport stream and that outputs an elementary stream;
a video and audio decoder that decodes the elementary stream and that outputs a video and audio signal; and
an on screen display multiplexer that overlaps operation screen over the video signal, the on screen display multiplexer being connected to the display.

10. An image display device comprising:
a display that shows an image based on image data;
a first interface to which a storage medium that has the image data is connected;
a second interface; and
a controller that makes the display show the image based on an input from the first or the second interface;
wherein the controller makes the display show a message that urges a user to connect the storage medium to the second interface when moving image data is detected in the storage medium through the first interface.

11. The image display device of claim 10, wherein the controller makes the display show the message after the controller has confirmed that the second interface is not connected to an apparatus.

12. The image display device of claim 10, wherein the first interface is a USB (Universal Serial Bus) interface.

13. The image display device of claim 10, wherein the second interface is an HDMI (High-Definition Multimedia Interface) interface or a composite video signal interface.

14. The image display device of claim 10, wherein the controller includes a processor and a memory, and the memory has a program for decoding still image data.

15. The image display device of claim 10, wherein the storage medium has a decoder for decoding the moving image data.

16. The image display device of claim 10, further comprising:
a tuner that receives a signal of digital broadcasting;
a demodulator that demodulates the signal inputted from the tuner and that outputs a transport stream;
a demultiplexer that demultiplexes the transport stream and that outputs an elementary stream;
a video and audio decoder that decodes the elementary stream and that outputs a video and audio signal; and
an on screen display multiplexer that overlaps operation screen over the video signal, the on screen display multiplexer being connected to the display.

17. A method for displaying an image by an image display device connected to a storage medium having image data via a first interface, the method comprising the steps of:
checking whether or not moving image data exist in the storage medium while playing a still image by an input from the first interface; and
changing the input from the first interface to a second interface when the moving data exists in the storage medium.

18. The method of claim 17, further comprising the step of:
instructing the storage media to decode the moving image data via the second interface after changing the input from the first interface to the second interface.

19. The method of claim 17, further comprising the steps of:
checking whether or not an apparatus is connected to the second interface before changing the input from the first interface to the second interface when the moving data exists in the storage medium; and
showing a message that urges a user to connect the storage medium to the second interface when the apparatus is not connected to the second interface.

20. The method of claim 17, further comprising the steps of:
checking whether or not the storage media is connected to the second interface by HDMI (High-Definition Multimedia Interface)—CEC (Consumer Electronics Control) after changing the input from the first interface to the second interface; and
showing a message that asks a user to play the moving image data by the storage medium when the storage media is not connected to the second interface by HDMI-CEC.
